(19) United States
(12) Patent Application Publication
(10) Pub. No.: US 2021/0316203 A1
(43) Pub. Date: Oct. 14, 2021

(54) HEATED HANDLE FOR SKI POLES

(71) Applicant: MAGNETUDE SPORT INC., Bromont (CA)

(72) Inventors: Olivier DUBOIS, Sherbrooke (CA); Olivier BRETON, Foster (CA)

(21) Appl. No.: 17/263,848

(22) PCT Filed: Jul. 29, 2019
(86) PCT No.: PCT/CA2019/000109

§ 371 Date: Jan. 27, 2021

Related U.S. Application Data
(60) Provisional application No. 62/711,460, filed on Jul. 27, 2018.

(30) Foreign Application Priority Data
May 10, 2019 (CA) 3042930

(51) Int. Cl. A63C 11/22; H05B 1/02; H01M 50/204; H01M 50/249; H01M 10/48; H01M 10/615; H01M 10/625; H01M 10/6571

(52) U.S. Cl. CPC A63C 11/222; A63C 11/228; H05B 1/0227; H01M 50/204; H01M 50/249; H01M 2220/20; H01M 10/615; H01M 10/625; H01M 10/6571; A63C 2203/12; H01M 10/486

(57) ABSTRACT

A heated handle for a ski pole includes a body mounted to a stick of the ski pole, the body defining an inner chamber. A heating mechanism is in the body and is adapted to emit heat through the body and onto a user's hand. A battery is provided to supply power to the heating mechanism. On-off and temperature level controls are also provided The heating mechanism includes at least one heating wire. The battery is located in the handle, within the stick or exteriorly along the stick, and can take the form of a battery pack. The body can define openings for allowing heat inside the body to reach the user's hand. A secondary heating mechanism is also provided to heat the batteries so as to maintain the temperature thereof above a predetermined temperature.

### CROSS REFERENCE TO RELATED APPLICATIONS

This Application claims priority on (1) U.S. Provisional Application No. 62/711,460, now pending, filed on Jul. 27, 2018, and on (2) Canadian Patent Application No. 3,042,930, now pending, filed on May 10, 2019, both of which are herein incorporated by reference.

### FIELD

The present subject matter relates to skiing and, more particularly, to ski poles.

### BACKGROUND

Skiing is a popular sport and there are various types of skiing, such as alpine or downhill skiing, cross-country skiing, freestyle skiing, etc. When practicing most of the types of skiing, the skier generally uses a pair of ski poles, also called sticks in certain countries. The pole includes an elongated shaft, a handle or handgrip provided at an upper end of the shaft and a basket at provided at an opposed lower end thereof. The shaft is typically made from aluminum, carbon fiber, steel, etc., and even bamboo is still used. The handle is usually made of a plastics material and is mounted around the upper end of the shaft. The basket is typically mounted at the lower end of the shaft, but is spaced from a pointed tip of the shaft. Various shapes and configurations of baskets exist, for different types of skiing and snow conditions. The basket extends transversally of the shaft, thus substantially perpendicularly of an axis of the shaft. The pointed tip is for penetrating the snow, and the basket is designed to limit such penetration and is thus a skiing aid for stopping the pole from sinking significantly into deep snow. See, for instance, U.S. Pat. No. 5,549,329 entitled “Ski Pole and Removable Hand Grip”, which issued on Aug. 27, 1996 to Wuerslin et al.

The handle can be provided with a strap (wrist strap) in the form of a loop, attached at its opposed ends to the handle and through which the skier passes his/her hand such that the strap is slipped over the wrist, with the skier gripping the handle so as to prevent the loss of the pole in the event of the skier failing. See, for instance, aforementioned U.S. Pat. No. 5,549,329, and also older U.S. Pat. No. 2,117,010 entitled “Ski Pole”, and which issued on Aug. 20, 1936 to Potter. Alternatively, such a loop can be integrally and substantially rigidly formed in the handle in a unitary construction, as seen, for example, in U.S. Pat. No. 4,493,494 entitled “Ski Pole Handle”, which issued on Jan. 15, 1985 to Feagin, Jr., and U.S. Design Pat. No. Des. 244,045 entitled “Ski Pole Handgrip or Similar Article”, which issued on Apr. 12, 1977 to Lah et al.

Skiing is often practiced under significantly cold weather conditions. Even though the skiers wear high quality gloves or milts that are well designed for skiing, it is common for the skiers' hands to become cold, as a result of the cold weather and/or a long skiing day. Furthermore, the handle is always somewhat exposed to the weather conditions and becomes itself cold, thereby transferring its coldness to the skiers' gloves and ultimately to his/her hands.

Therefore, it would be desirable to provide a ski pole better suited for cold weather conditions in order to maintain the skier's hands at a comfortable temperature level.

### SUMMARY

It would thus be desirable to provide a novel ski pole.

It would also be desirable to provide a novel handle for ski poles.

The embodiments described herein provide in one aspect a heated handle for a ski pole, comprising:
a body adapted to be mounted to a stick of a ski pole, the body defining an inner chamber;
a heating mechanism at least partly located in the inner chamber and adapted to emit heat through the body and onto a user's hand;
at least one battery for supplying the heating mechanism; and
at least one control for controlling at least one of the state of the heating mechanism and a temperature level thereof.

Also, the embodiments described herein provide in another aspect a heated handle for a ski pole, comprising:
a body adapted to be mounted to a stick of a ski pole;
a heating mechanism adapted to emit heat through the body and onto a user's hand;
a power supply for the heating mechanism; and
a control that is operable to switch the heating mechanism between on and off positions.

Furthermore, the embodiments described herein provide in another aspect a ski pole, comprising:
a stick;
a handle provided at an upper end of the stick;
a heating mechanism adapted to emit heat through the handle and onto a user's hand;
a power supply for the heating mechanism; and
a control that is operable to switch the heating mechanism between on and off positions.

Furthermore, the embodiments described herein provide in another aspect a handle for a ski pole, comprising:
a body adapted to be mounted to a stick of a ski pole; and
a security system on the handle, the security system being adapted to be engaged to a part of a ski rack such that when the ski rack is in a locked position thereof, the ski pole is secured to the ski rack via the security system.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment.

FIG. 1 is a schematic perspective illustration of a handle for ski poles in accordance with an exemplary embodiment;

FIG. 2 is a schematic vertical cross-sectional view of the handle for ski poles in accordance with an exemplary embodiment;

FIG. 3 is a schematic vertical cross-sectional view of a handle for ski poles in accordance with an exemplary embodiment;

FIG. 4 is a schematic vertical cross-sectional view of a handle for ski poles in accordance with an exemplary embodiment;

FIG. 5 is a schematic vertical cross-sectional view of a handle for ski poles in accordance with an exemplary embodiment;

FIG. 6 is a schematic side view of a handle for ski poles in accordance with an exemplary embodiment;

FIG. 7 is a schematic perspective view of part of a ski pole provided with a battery pack thereon in accordance with an exemplary embodiment;

FIG. 8 is a side view of a conventional ski pole;

FIG. 9 is an exploded view of a handle for ski poles in accordance with another exemplary embodiment;

FIG. 10 is a schematic vertical cross-sectional view of the handle for ski poles of FIG. 9;

FIG. 11 is an elevation view of a ski pole provided with the handle of FIG. 9;

FIG. 12 is a schematic view of a main heating element of the handle for ski poles of FIG. 9;

FIG. 13 is a perspective view of the ski pole secured to a ski rack in accordance with an exemplary embodiment;

FIG. 14 is a schematic view of the batteries and the various heating elements of the handle for ski poles, in accordance with an exemplary embodiment;

FIG. 15 is a schematic exploded view of the battery casing of the handle for ski poles, including the batteries, the secondary heating elements and the sensors, in accordance with an exemplary embodiment;

FIG. 16 is a schematic view of the control panel of the handle for ski poles, in accordance with an exemplary embodiment; and

FIGS. 17A and 17B are schematic exploded views showing a position, within the handle for ski poles, of the main heating element of the handle for ski poles in accordance with an exemplary embodiment.

### DESCRIPTION OF VARIOUS EMBODIMENTS

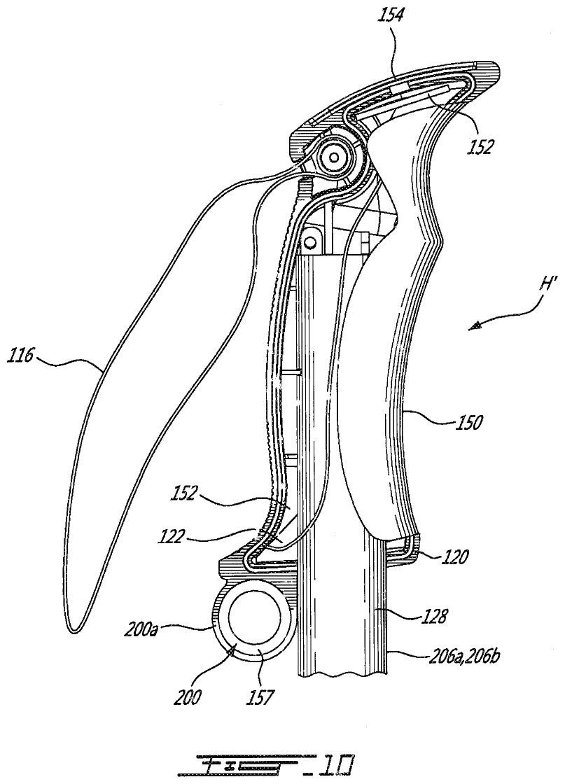

FIG. 8 shows a conventional ski pole P, which includes an elongated shaft 10, a handle or handgrip 12, a basket 14 and a strap (wrist strap) 16. A lower end of the shaft 10 defines a pointed tip 18, and the basket 14 is mounted to the shaft 10 in a spaced apart relationship with respect to the pointed tip 18, for reasons set forth hereinabove. The handle 12 is mounted at an upper end el the shaft 10, and the strap 16 is attached to an upper end of the handle 12.

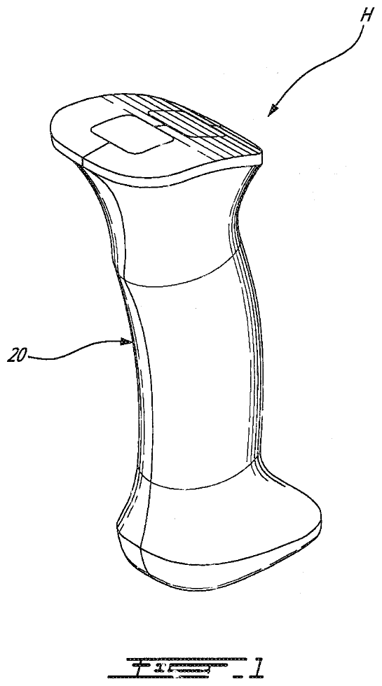

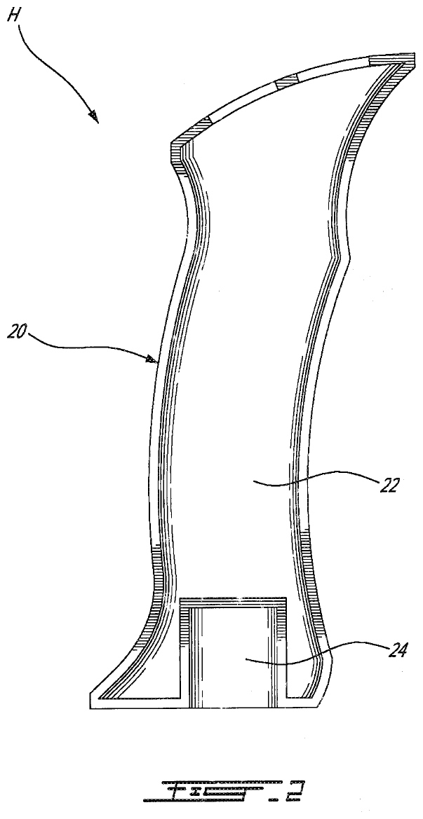

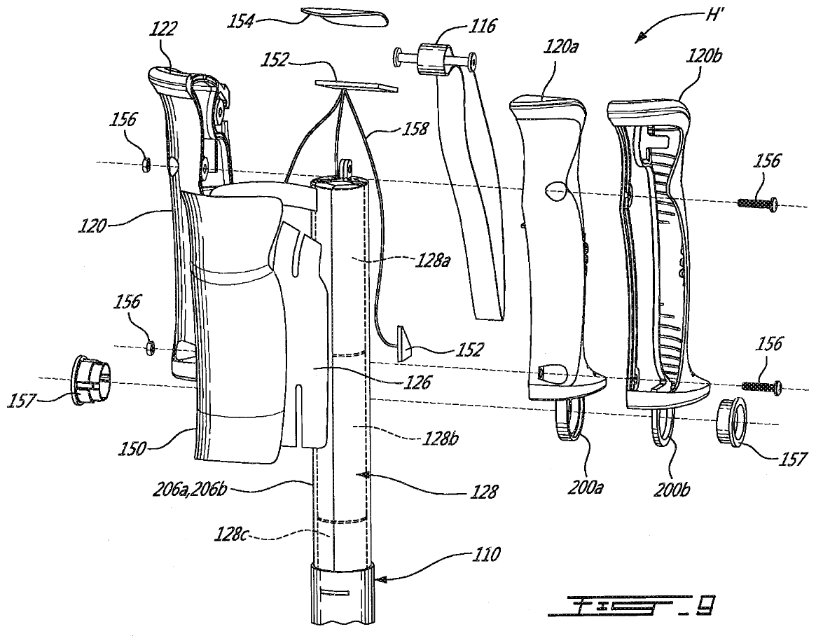

The current subject matter relates to a handle H for ski poles, and reference is made, for instance, to FIGS. 1 to 3. The handle H, which is of ergonomic design and which is typically made of a suitable plastics material, includes a body or shell 20 that is hollow, such as by defining an inner chamber 22. A lower cavity 24 is provided at the bottom of the body 20, the cavity 24 being adapted for accommodating, in a secure manner, an upper end of the shaft 10 (see FIG. 7) of the ski pole.

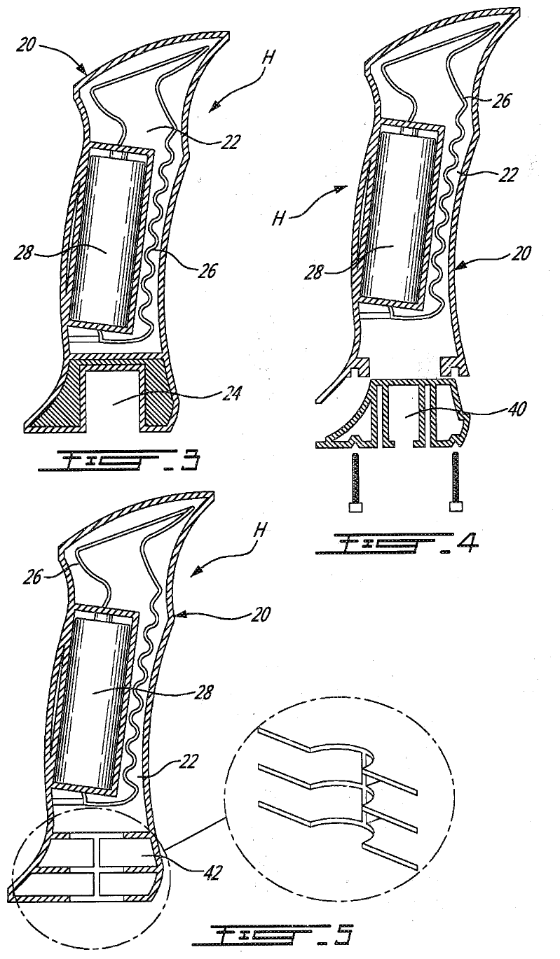

For heating the Handle H from the inside out, there is typically provided at least one healing wire 26, located within the inner chamber 22, as seen, for instance, in FIGS. 3 to 5. Power to the heating wire 26 is provided by at least one battery, or the like, such battery 28 shown in FIGS. 3 to 5, and herein located within the inner chamber 22. Other suitable means can be used in lieu of the heating wire 26 and the battery 28 shown in FIGS. 3 to 5.

For example, FIG. 7 illustrates a battery pack 30 mounted to the shaft 10 of the ski pole, instead of within the inner chamber 22 as in FIGS. 3 to 5. The battery pack 30 is herein shown as including a pair of batteries 32, encased in a housing 34. The housing 34 is firmly mounted to the shaft 10 via, for instance, a pair of straps 36, clamps, or any other suitable anchoring system. The housing 34 defines an inner concave wall 38 adapted to follow the curved outside surface of the shaft 10. The battery pack 30 can be removably mounted to the shaft 10, thereby allowing the user to disengage it from the shaft 10, so as to proceed, for instance, to replacing the batteries 32.

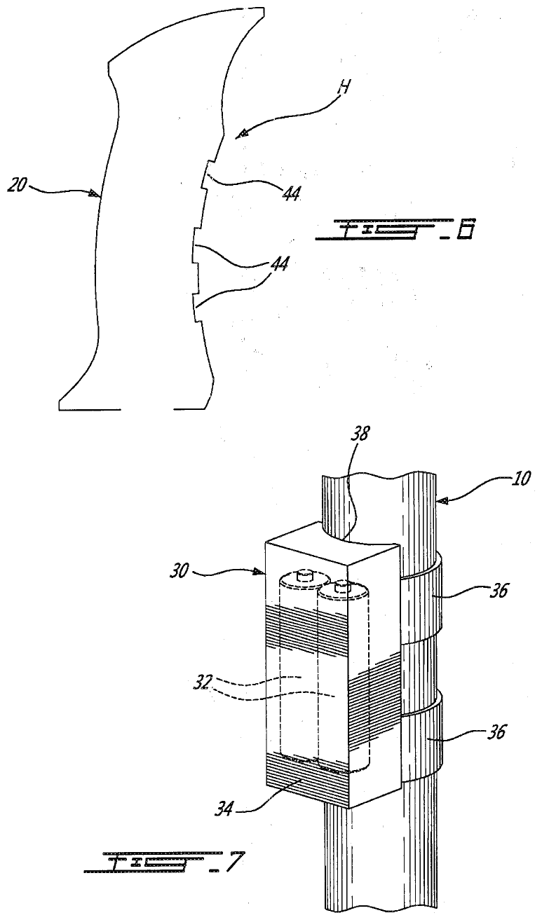

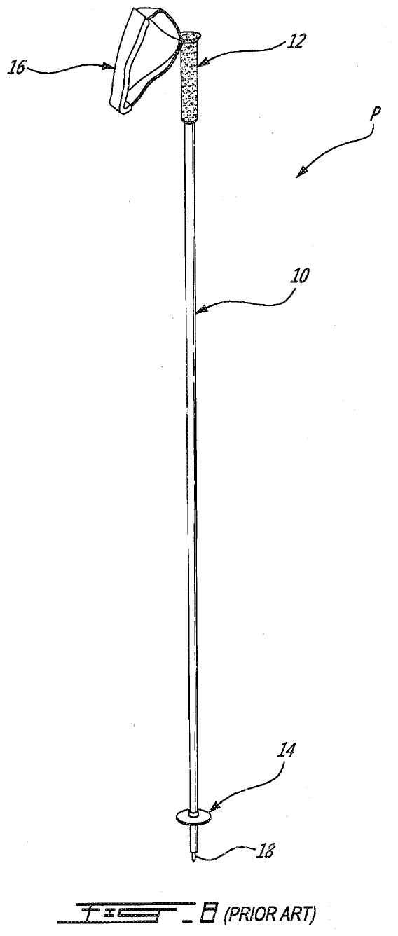

Various connecting arrangements can be provided at the bottom of the body 20 of the handle H for mounting the handle H to the shaft 10, such as the lower cavity 24 of FIG. 3, as well as the configurations 40 and 42 shown respectively in FIGS. 4 and 5.

If the body 20 is made from a material with limited capability for transferring heat from the heating source (for instance, the heating wire 26) to the outside of the body and thus to the skier's hand, passages or openings 44 can be defined through the body 20 (see FIG. 6), so that heat can be conveyed from the body 20 to the skier's hand.

It is also contemplated to include the power source (battery, battery pack, etc.) within the hollowness of the shaft 10.

Furthermore, a self-contained unit, wherein the complete heating mechanism is provided in the handle H, could also be designed so that the handle can be fitted on existing ski poles, that is by removing the ski pole's original handle from the shaft thereof, and replacing the original handle with a self-contained heating handle of the present subject matter.

The material used for the body 20 should be hard and efficient in transferring the heat generated within the body 20, for instance within the inner chamber 22. The material must also be able to withstand the heat so generated.

The battery 28 or battery pack 30 can be rechargeable, such as via a micro-USB port, a USB port, or any other suitable system. Considerations are to be given to the type of battery; its power; its charging time (in case of rechargeable batteries); its battery life or, for rechargeable batteries, the operating duration of a full charge.

Consideration is also to be given to the PCB and to the integration of the electronic components required for the operation and control of the heating source, including the method of switching on and off the heating source, overheat protection, etc.

The shell or body 20 could be made out of a polymer, and could be made of unitary construction (monocoque) or of two halves. Consideration is to be given to the body 20 being waterproof/sealed to protect the internal components located e.g. in the inner chamber 22. The body could be made to be completely sealed, i.e. with an IP-67 rating.

The handle H should be able to sustain temperatures within the approximate range of −40° C. to 85° C. The handle H should also be resistant to abrasives, UV light and impacts.

Regarding the electronic components, there would be a PCB disposed in the upper part of the inner chamber 22; a charge port for the battery(ies), which is sealed or protected; at least one rechargeable lithium batter; and a user interface that is simple, i.e. one on-off switch (push button, toggle, etc.), a control for adjusting the temperature (button, dial, etc.), and possibly a light signal.

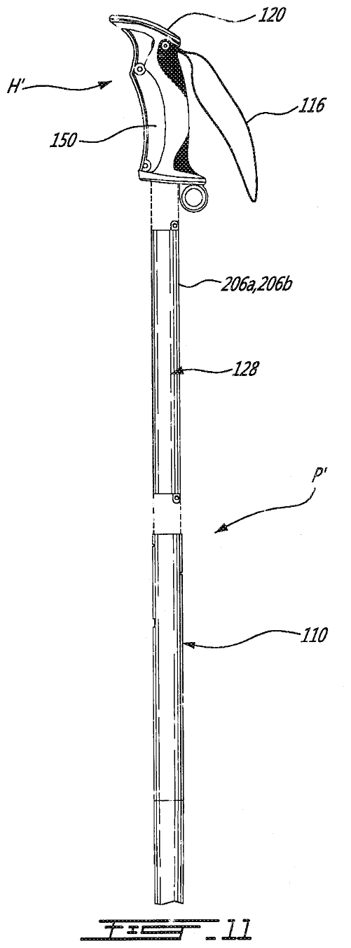

Now referring to FIGS. 9, 10 and 11, another embodiment is shown thereat, wherein a ski pole P′ is depicted, including a handle H′, which is a variant of the afore-described handle H. In the following description and drawings that pertain thereto, components of the handle H′ which are identical in function and identical and/or similar in structure to corresponding components of the handle H of FIGS. 1 to 7 bear the same reference as in FIGS. 1 to 7, but are tagged with the prefix “1” and are thus in the hundreds with the last two digits thereof being identical to the reference numerals of corresponding components of the handle H. New components (or components not identified for handle H) provided in the handle H′ start at reference numeral 150.

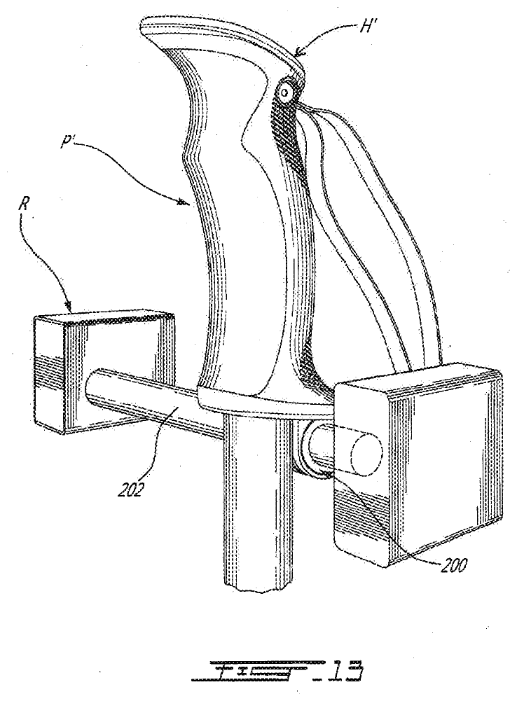

The handle H′ is adapted to be mounted to an upper end of the shaft 110 (see FIG. 11) of the ski pole P′. The shaft 110 is made, for instance, of carbon fiber. A strap 116 is made, for instance, a fabric material.

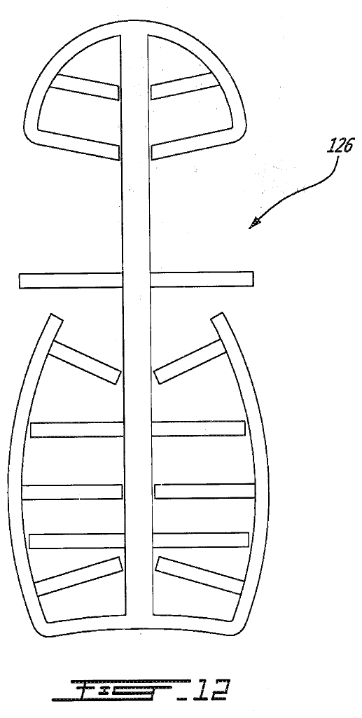

As best seen in FIGS. 9 and 10, the handle H′ includes a hollow body or shell 120, which is, for instance, made of a plastics material with overmold and which defines an inner chamber 122. The shell 120 includes a pair of sub-components 120a and 120b. A thin aluminum plate 150 is provided on the outside of the shell 120, and is located on the forwardly-facing side of the handle H′. The aluminum plate 150 is adapted to conduct heat emanating from a heating element 126 to the skier's hand. More particularly, the skier's hand (or glove or mitten) is applied directly on the aluminum plate 150.

The heating element 126 is adapted to transmit heat to the aluminum plate 150 at different settings. For example, the heating element 126 can be set at 30° C., 38° C., 46° C. or 54° C. Batteries 128 are provided inwardly of the heating element 126. Three batteries are herein shown. Each battery 128 is, for instance, an LG 18650MH1 (3.2 Ah).

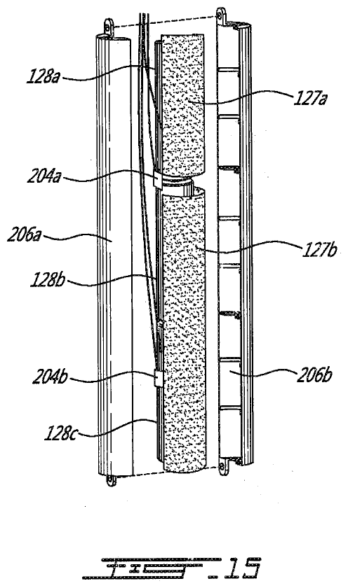

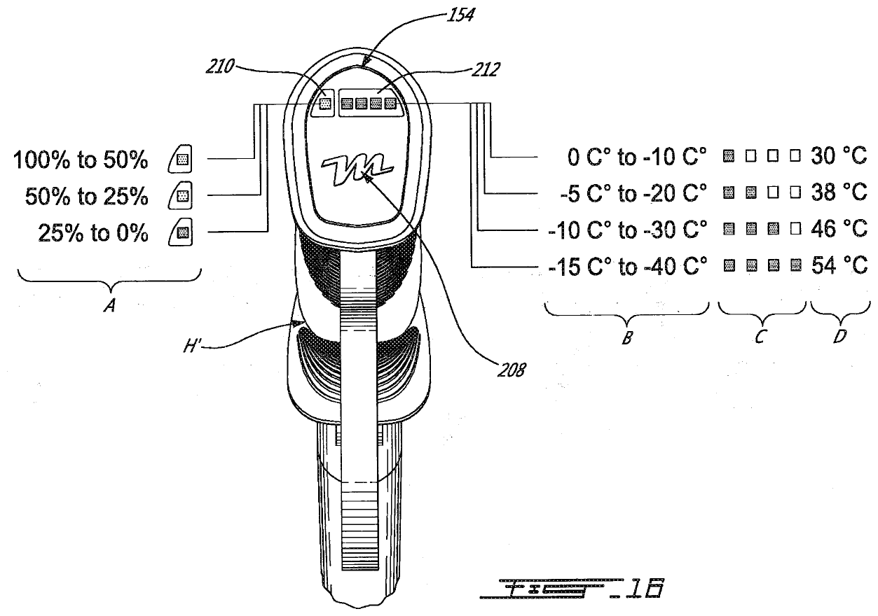

These batteries 128 do not resist well to cold temperatures, whereby the batteries 128 are wrapped within healing elements to keep the batteries 128 warm. The uppermost battery 128a, which requires less heating than the two lowermost batteries 128b and 128c, has its own heating element, whereas the two bottom batteries 128b and 128c share another heating element. Therefore, as schematically illustrated in FIG. 14, two secondary heating elements 127a and 127b are provided for heating the batteries 128. More particularly, the heating element 127a is adapted to heat the uppermost battery 128a, whereas the heating element 127b is adapted to heat the two lower batteries 128b and 128c. Also referring to FIG. 15, a pair of temperature sensors 204a and 204b are provided, wherein the temperature sensor 204a is adapted to detect the temperature of the uppermost battery 128a, whereas temperature sensor 204b is adapted to detect the temperature of the two lowermost batteries 128b and 128c. Depending on their readings, the temperature sensors 204a and 204b will cause none, either one, of both of the secondary heating elements 127a and 127b to be activated.

The secondary heating elements 127a and 127b are adapted to maintain the batteries 128 at a temperature, for instance, of around 0° C., using the temperature sensors 204a and 204b installed respectively on battery 128a and on batteries 128b/128c. Indeed, thermal analyses and duration of use optimisation analyses have revealed that 0° C. Is a choice temperature for the batteries 128. The secondary heating elements 127a and 127b can be activated even if the main heating element 126 is off, for instance in order to prevent the batteries 128 from become discharged, or even damaged, when the poles P′ are left outside, e.g. when the poles P′ are not being used,

References 206a and 206b denote a plastic casing for holding therein the batteries 128 (128a, 128b and 128c), secondary heating elements 127a and 127b and the temperature sensors 204a and 204b.

Reference numeral 152 denotes an electrical circuit, including a PCB and a Micro-USB charging port. A control panel 154 is provided at the upper end of the shell 120. The control panel 154 takes the form of a membrane with five (5) small LED lights, which allows an operation mode to be selected and which shows the so selected mode, including the set temperature of the heating element 126. Further details of the control panel 154 are provided hereinbelow.

Reference numeral 156 denotes screws and nuts for securing together the sub-components 120a and 120b of the shell 120. Various wires 158 are provided for connecting the relevant electrical components.

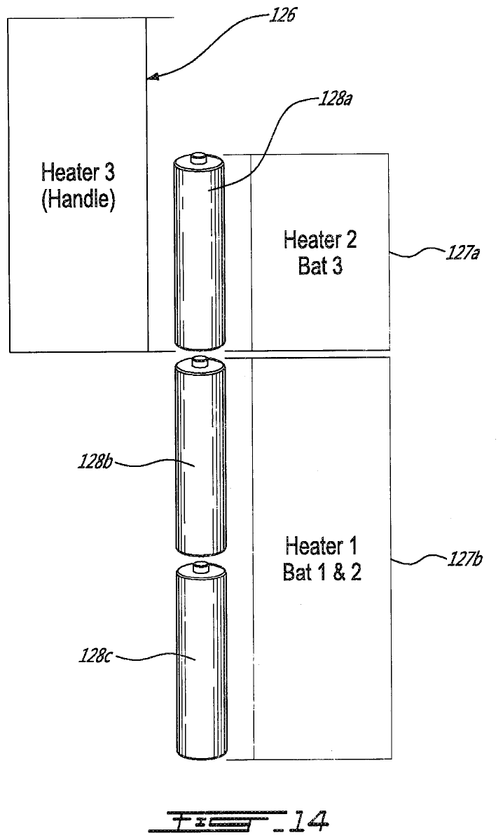

In FIGS. 9 and 10, the handle H′ also shown to include a security ring 200, which includes mating elements 200a and 200b that held together by mounting rings 157. As seen in FIG. 13, the security ring 200 is used to lock the ski poles P′ to a ski rack R, that is by sliding the security ring 200 along a metal rod 202 of the ski rack R such that, when the ski rack is in its schematic position shown in FIG. 13, the ski poles P′ cannot be removed therefrom.

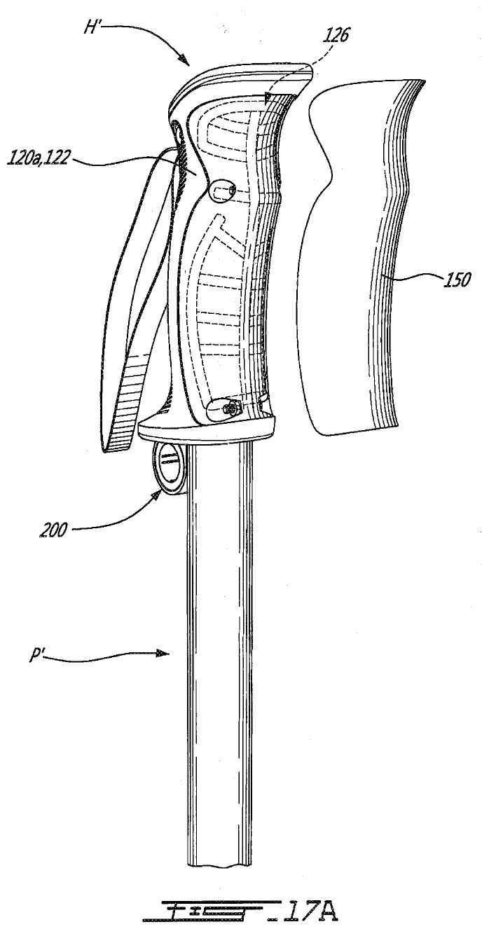

Referring now to FIG. 16, the control panel 154 includes a control button 210, an illuminated battery charge indicator 210, and an intensity panel 212 that herein includes four (4) LEDs. The battery charge indicator 210 can adopt three colors, which each indicate a level of charge left in the batteries 128, with this being schematically shown in section A of FIG. 16. Section B in FIG. 16 schematically illustrates four (4) ambient temperature ranges, and section C shows four (4) heating intensities that can be selected depending on conditions, typically on the outside ambient temperature. Therefore, a different heating intensity of the main heating element 126 is selected for each such temperature range. Section D in FIG. 16 denotes the general temperature at which the main heating element 126 is to be heated for each of the four possible heating intensities.

The heating intensities are selected by the user by pressing an appropriate number of times on the control button 208. For instance, for an ambient temperature of between −10° C. and −30° C., the user will push on the control button 208 (repeatedly) until three LEDs are illuminated on the intensity panel 212, whereby the main healing element 126 will be heated by the batteries 128 to an operating temperature of 46° C.

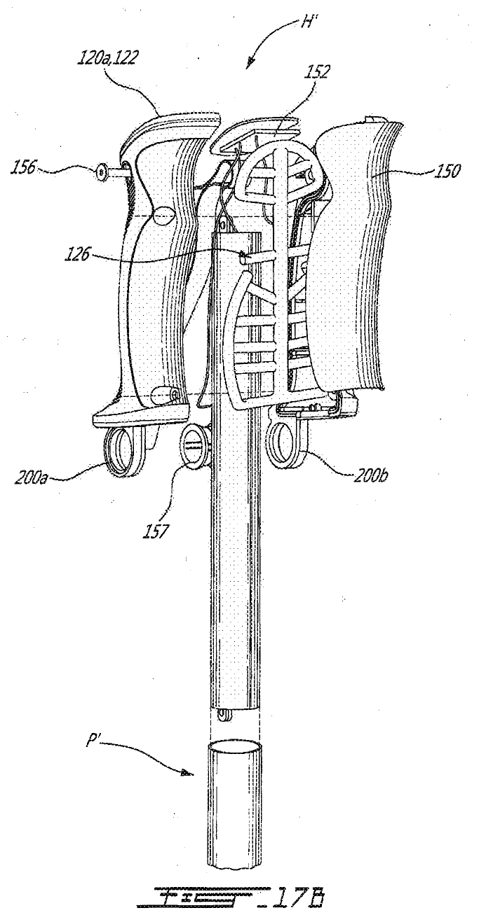

FIG. 12 shows in isolation the main heating element 126. FIGS. 17 and 18 show the position of the main heating element 126 within the handle H′, i.e. relative to the body sub-component 120a, the inner chamber 122, the aluminum plate 150 and the electrical circuit (PCB) 152. The main heating element 126 is positioned between the plastic body sub-component 120a and the aluminum plate 150.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

1. A heated handle for a ski pole, comprising:
a body adapted to be mounted to a stick of a ski pole, the body defining an inner chamber;
a heating mechanism at least partly located in the inner chamber and adapted to emit heat through the body and onto a user's hand;
at least one battery for supplying the heating mechanism; and
at least one control for controlling at least one of the state of the heating mechanism and a temperature level thereof.

2. The heated handle of claim 1, wherein the body defines a lower cavity adapted to securely receive therein an upper end of the stick.

3. The heated handle of any one of claims 1 and 2, wherein the heating mechanism includes at least one heating wire.

4. The heated handle of any one of claims 1 to 3, wherein the battery is mounted in the inner chamber.

5. The heated handle of any one of claims 1 to 3, wherein the battery is adapted to be mounted at least partly within the stick.

6. The heated handle of any one of claims 1 to 5, wherein the battery is part of a battery pack.

7. The heated handle of any one of claims 1 to 6, wherein the battery is rechargeable.

8. The heated handle of claim 6, wherein the battery pack is adapted to be mounted on an outside surface of the stick.

9. The heated handle of any one of claims 1 to 8, wherein the body defines openings for allowing heat to reach the users hand.

10. The heated handle of claim 9, wherein the openings extend from the inner chamber to an outside of the body, thereby allowing heat to escape the inner chamber and reach the user's hand.

11. The heated handle of any one of claims 1 to 10, wherein the control includes a first control that is operable to switch the heating mechanism between on and off positions.

12. The heated handle of any one of claims 1 to 11, wherein the control includes a second control that is operable to adjust an intensity of the heating mechanism.

13. The heated handle of any one of claims 1 to 12, wherein a conductive plate is provided of an outside of the body, the conductive plate being adapted to be heated by the heating mechanism.

14. The heated handle of claim 13, wherein the heating mechanism is provided between the body and the conductive plate.

15. The heated handle of any one of claims 13 to 14, wherein the conductive plate is located on a forwardly-facing side of the handle.

16. The heated handle of any one of claims 13 to 15, wherein the conductive plate is located such that a skier's hand or hand covering is adapted to be applied directly on the conductive plate when the ski pole is in use.

17. The heated handle of any one of claims 1 to 16, wherein the heating mechanism is adapted to transmit heat to the conductive plate at different settings, typically the heating mechanism can be set at 30° C., 38° C., 46° C. or 54° C.

18. The heated handle of any one of claims 1 to 17, wherein the at least one battery is provided inwardly of the heating mechanism

19. The heated handle of any one of claims 1 to 18, wherein there are provided at least two batteries, each battery being, for instance, an LG 18650MH1 (3.2 Ah).

20. The heated handle of any one of claims 1 to 19, wherein at least one secondary heating element is provided for heating the battery.

21. The heated handle of claim 20, wherein the heating element is wrapped around the battery.

22. The heated handle of any one of claims 20 to 21, wherein there are provided at least two batteries and at least one secondary heating element for each battery.

23. The heated handle of any one of claims 20 to 22, wherein there are provided at least three batteries and at least first and second secondary heating elements, the first secondary heating element being adapted to heat an uppermost battery, whereas the second secondary heating element is adapted to heat a pair of lower batteries.

24. The heated handle of any one of claims 20 to 23, wherein there is provided at least one temperature sensor for each secondary heating element, the temperature sensor being adapted to measure a temperature of the battery and trigger the secondary heating element if the temperature of the battery is lower than a predetermined value.

25. The heated handle of any one of claims 20 to 24, wherein the secondary heating element is adapted to maintain the battery at a temperature, for instance, of around 0° C.

26. The heated handle of any one of claims 20 to 25, wherein the secondary heating element is capable of being activated even if the heating mechanism of the handle is off.

27. The heated handle of claim 24, wherein a battery casing is provided for holding therein the battery(ies), the secondary heating element(s), and the temperature sensor(s).

28. The heated handle of any one of claims 1 to 27, wherein the battery is rechargeable, for instance via Micro-USB charging port.

29. The heated handle of any one of claims 1 to 28, wherein a control panel is provided on an outside of the body, typically at an upper end thereof.

30. The heated handle of claim 29, wherein the control panel includes a selector for choosing a heating intensity of the heating mechanism.

31. The heated handle of claim 30, wherein the selector includes a control button, such as a push button covered by a membrane.

32. The heated handle of any one of claims 30 to 31, wherein the control panel includes at least first and second lights, typically LEDs, the first light being adapted to indicate a level of remaining charge in the battery, whereas the second light is adapted to show an intensity setting of the heating mechanism.

33. The heated handle of claim 32, wherein the second light includes at least two lights for showing two intensity settings of the heating mechanism, and wherein each intensity setting is associated with a range of ambient temperatures, whereby an appropriate intensity setting can be selected by the user via the selector depending on the ambient temperature.

34. The heated handle of claim 33, wherein the second light includes at least four lights for allowing a selection by the user between four intensity settings of the heating mechanism.

35. The heated handle of claim 32, wherein the first light is adapted to adopt one of at least three different colors, each color indicating a different level of remaining battery charge.

36. The heated handle of any one of claims 1 to 35, wherein there is provided a security system on the handle, the security system being adapted to be engaged to a part of a ski rack such that when the ski rack is in a locked position thereof, the ski pole is secured to the ski rack via the security system.

37. The heated handle of claim 36, wherein the security system includes a ring through which the part of the ski rack is adapted to extend.

38. The heated handle of any one of claims 36 to 37, wherein the security system is adapted to engage a rod of the ski rack.

39. A heated handle for a ski pole, comprising:
a body adapted to be mounted to a stick of a ski pole;
a heating mechanism adapted to emit heat through the body and onto a user's hand;
a power supply for the heating mechanism; and
a control that is operable to switch the heating mechanism between on and off positions.

40. A ski pole, comprising:
a stick;
a handle provided at an upper end of the stick;
a heating mechanism adapted to emit heat through the handle and onto a user's hand;
a power supply for the heating mechanism; and
a control that is operable to switch the heating mechanism between on and off positions.

41. A handle for a ski pole, comprising:
a body adapted to be mounted to a stick of a ski pole; and
a security system on the handle, the security system being adapted to be engaged to a part of a ski rack such that when the ski rack is in a locked position thereof, the ski pole is secured to the ski rack via the security system.

42. The handle of claim 41, wherein the security system includes a ring through which the part of the ski rack is adapted to extend.

43. The heated handle of any one of claims 41 to 42, wherein the security system is adapted to engage a rod of the ski rack.
